(19) United States
(12) Patent Application Publication
(10) Pub. No.: US 2008/0075829 A1
(43) Pub. Date: Mar. 27, 2008

(54) COMPOSITIONS AND RELATED METHODS USING SOY ALBUMIN TO PROVIDE A VARIETY OF HEALTH RELATED BENEFITS

(76) Inventor: Shil. C. Kothari, Fairfield, CA (US)

Correspondence Address: KATHRYN P.WILKE;C/O GAW VAN MALE, 769 HORIZON DRIVE, MARTINEZ, CA, 94553, US

(21) Appl. No.: 11/534,631

(22) Filed: Sep. 22, 2006

(51) Int. Cl. A23L 1/20

(52) U.S. Cl. 426/634

(57) ABSTRACT

Compositions and related methods using soy albumin to provide a variety of health-related benefits. University controlled studies demonstrated that an effective amount of soy albumin provided to a human daily for eight weeks provided unexpected synergistic results that provided a variety of health-related benefits. In particular, eight weeks of supplementation with soy albumin alone and in combination with fenugreek, phaseolamine, and bicarbonate resulted in 1) weight loss, 2) reduced total cholesterol levels, 3) reduces LDL cholesterol levels, 4) increased HDL or good cholesterol levels, 5) improved total cholesterol/HDL ratio, 6) improved LDL/HDL ratio, ratio, 7) reduced triglyceride levels, 8) increased serum serotonin levels, 9) decreases fasting blood glucose levels, and 10) prevention, improvement or treatment of Syndrome X or the cardiovascular or metabolic factors that cause Syndrome X.

### FIELD OF THE INVENTION

The present disclosure relates generally to using compositions and related methods using soy albumin improve a variety of health-related factors. More specifically, the present disclosure relates to using soy albumin to provide various health benefits, including but not limited to, 1) weight loss and decreased BMI, 2) reduced total cholesterol levels, 3) reduced LDL cholesterol levels 4) increased HDL or “good” cholesterol levels, 5) improved total cholesterol/HDL ratio, 6) improved LDL/HDL ratio, 7) reduced triglyceride levels, 8)increased serum serotonin levels, 9) decreased fasting blood glucose levels and 10) prevention, improvement or treatment of Syndrome X or the cardiovascular or metabolic factors that cause Syndrome X.

### BACKGROUND OF THE INVENTION

The term “soy” is used to refer to many products derived from the soybean. It is commonly accepted that in terms of health and wellness, the two most important dietary supplements derived from soybeans are isolated/concentrated soy proteins and soy extracts which contain a high amount of compounds called isoflavones. Isoflavones have been associated with a wide variety of beneficial health effects including protection from cancer and osteoporosis to reduction in hot flashes and other symptoms of menopause.

Depending on the method of processing, many soy foods contain a relatively high content of chemical compounds called isoflavones, which possess weak estrogen-like effects. Under conditions of high estrogen exposure, which may promote certain cancers, the isoflavone compounds tend to block the adverse effects of estrogen and may prevent growth of cancer cells. Under conditions of low estrogen exposure, such as during menopause, the isoflavones tend to act as weak estrogens, which may be just enough to help alleviate some of the symptoms associated with menopause, such as hot flashes, headaches and mood swings.

In general, soybeans, like most legumes, have a relatively high protein content (35%-40% for whole soy beans). After processing, protein powders composed of soy concentrate provide about 70% protein, while the even more concentrated protein source, soy isolate may contain close to 90% protein. Interestingly, due in large part to the way the soy is processed, most if not all soy proteins contain at most minute amounts of soy albumin. As a protein source, soy protein tends to be somewhat low in the sulfur-containing amino acids such as cysteine and methionine. This has led to the perception that soy protein is a less desirable source of dietary protein than those foods with higher sulfur content, such as meat, milk and eggs. When the digestibility of the protein is taken into account, however, isolated soy protein scores on par with egg white and milk proteins.

Isoflavones from soy are the richest dietary source of isoflavones. Typical soyfoods like tofu might provide 1-4 mg/g or about 40-100 mg of isoflavones per ounce. Soymilk provides about 100-150 mg of isoflavones per 8-ounce glass. The isoflavones function as phytoestrogens in the body, where they possess weak estrogen-like effects. The two primary isoflavones found in soy are daidzein and genistein, both of which have been associated with the health benefits mentioned above. The chemical structure of isoflavones is similar enough to that of estrogen so that they can bind to the estrogen receptor on cells, yet different enough so that they only perform very weak estrogen effects.

For the different soy-based protein powders on the market, the isoflavone content can vary significantly, from almost zero for those products extracted using alcohol, to certified levels of 2-5 mg per gram of protein. In many Asian countries, where the incidence of heart disease, cancer and menopausal symptoms is low, the daily isoflavone intake is estimated at 25-50 mg per day. In contrast, the average Western intake of isoflavone is less the 5 mg per day.

Epidemiological studies suggest that Asian diets, which typically include a higher amount of soy protein that Western diets, may provide protection from several cancers, including those of the breast, prostrate gland and colon. As mentioned above, the action of isoflavone as weak estrogens allows them to bind to estrogen receptors and block some of the detrimental effects of estrogen, including the promotion of cancer cell growth. Tamoxifen, a prescription drug for treating breast cancer, is though to act as an anti-estrogen by binding to the estrogen receptor and “blocking” the growth-promoting effects is estrogen in cancer cells. Accordingly, women using tamoxifen have a lower incidence of breast cancer and an estimated 30-40% reduction in breast cancer cell growth rate. The isoflavones in soy are chemically similar to tamoxiphen and, therefore, may also reduce the risk of hormone-dependent cancers via the same “estrogen-blocking” mechanism.

Soy protein consumption has also been shown to reduce bone loss and slow calcium loss in an animal model of osteoporosis, suggesting a possible beneficial role in preventing osteoporosis in humans. A diet high in soy protein has also been shown to improve bone density after six months. In addition, soybeans contain a relatively high calcium content, a large portion of which may be retained in soy protein powders. It is also interesting to note that soy protein seems to cause loss of calcium from the body compared to other dietary sources of protein, which may promote calcium loss and bone breakdown at high levels. Isoflavone, a synthetic isoflavone drug prescribed in Europe, is metabolized in the body into daidzein, and has potent effects on reducing bone resorption in postmenopausal women.

In some studies, consumption of certain soy proteins has been associated with providing protection against heart disease. More specifically, in the past soy protein has been associated with reducing serum cholesterol and triglyceride levels which is thought to help protect against coronary heart disease. Recently, an American Heart Association committee reviewed a decade of studies on the health benefits of soy and concluded that soy-based foods and soy protein supplements don't significantly lower cholesterol. Their finding, which were published in the American Heart Association's scientific journal Circulation, at the beginning of 2006, has persuaded most if not all of the scientific community that soy, including soy proteins, have no appreciable effect on lowering LDL cholesterol or triglyceride levels or increasing HDL or good cholesterol levels.

The American Heart Association committee determined that although previous studies had shown that eating large amounts of soy protein lowered cholesterol, subsequent research found that soy protein only minimally reduced LDL (“bad”) cholesterol and had no effect on HDL (“good”) cholesterol or triglycerides. In addition, the minimal reduction in LDL cholesterol came only from eating significant amounts of protein, which is much more than the relatively small amounts found in most foods. Additionally, the American Heart Association also performed a separate analysis of soy isoflavones and found they had no effect on lowering LDL cholesterol.

Based on these findings, presently the American Heart Association committee does not recommend using soy-based foods and supplements for reducing cholesterol. Unfortunately, other known treatments for reducing LDL cholesterol and triglyceride levels and increasing HDL cholesterol levels can often be difficult to administer, cause serious and undesirable side effects and often become less effective over time. Accordingly, there exits a need for a product that consistently, effectively and safely reduces cholesterol and triglyceride levels in mammals. The present invention provides these and other benefits and advantages.

Additionally, another well known ailments that effects many tens of individuals throughout the world is Syndrome X. Syndrome X (or metabolic syndrome) is often defined by obesity, cardiovascular disease and insulin resistance or diabetes. The American Heart Association (AHA) has indicated the Syndrome X in humans is characterized by a group of metabolic risk factors. More specifically, the AHA identified the following metabolic risk factors as a contributing to Syndrome X:
1. Abdominal obesity (excessive fat tissue in and around the abdomen);
2. Atherogenic dyslipidemia (blood fat disorders—high triglycerides, low HDL cholesterol and high LDL cholesterol—the foster plaque buildups in artery walls);
3. Elevated blood pressure;
4. Insulin resistance or glucose intolerance (the body can't properly use insulin or blood sugar);
5. Prothrombotic state (e.g., high fibrinogen or plasminogen activator inhibitor-1 in the blood; and Prothrombotic state (e.g., elevated C-reactive protein in the blood).

The AHA and others have also acknowledged that people with Syndrome X have an increased risk of coronary heart disease and other diseases related to plaque buildups in artery walls (e.g., stroke and peripheral vascular disease) and type 2 diabetes. Unfortunately, Syndrome X has become increasingly common in the United States. The AHA has estimated that about 20%-25% of the adults in the United States (over 50 millions Americans) have Syndrome X.

The AHA also has indicated that the dominant underlying risk factors for Syndrome X appear to be abdominal obesity and insulin resistance. Insulin resistance is a generalized metabolic disorder, in which body can't use insulin efficiently. This is why Syndrome X is also called insulin resistance syndrome. Other metabolic risk factors for Syndrome X include physical inactivity, aging and hormonal imbalance.

Unfortunately, some people are genetically predisposed to insulin resistance. It is well accepted that acquired metabolic risk factors, such as excess body fat and physical, can elicit insulin resistance and result in Syndrome X in these people. For individuals that are genetically predisposed to insulin resistance and, as a result, predisposed to acquiring Syndrome X, it is especially important to improve, control or eliminate the metabolic rick factors thought to cause insulin resistance and Syndrome X. It is believed that most people with insulin resistance have abdominal obesity. Accordingly, it is believed that abdominal obesity may play a larger role in causing insulin resistance Syndrome X than other metabolic risk factors. It is well known that abdominal obesity can be controlled or reduced by overall weight loss and reduction of BMI.

Unfortunately, at the present, the biologic mechanisms of insulin resistance at the molecular level and how certain metabolic risk factors act to cause insulin resistance and Syndrome X aren't fully understood and appear to be complex. Similarly, at the present, the biological mechanisms of Syndrome X are also complex and not fully understood.

Presently, there is no universally-accepted criteria for diagnosing Syndrome X. The AHA acknowledges that the criteria proposed by the National Cholesterol Education Program (NCEP) Adult Treatment Panel III (ATP III), are the most current and widely used criteria for diagnosing Syndrome X.

Additionally, the AHA and the National Heart, Lung, and Blood Institute recommend that the Syndrome X or metabolic syndrome be identified or diagnosed by the presence of three or more of the following metabolic risk factors:
1. Central obesity as measured by an elevated waist circumference:
   Men—Equal to or greater than 40 inches (102 cm)
   Women—Equal to or greater than 35 inches (88 cm )
2. Elevated triglycerides:
   Equal to or greater than 150 mg/dL
   Reduced HDL (“good”) cholesterol:
      Men—Less than 40 mg/dL
      Women—Less than 50 mg/dL
3. Elevated Blood pressure:
   Equal to or greater than 130/85 mm/Hg
4. Elevated fasting glucose
   Equal to or greater than 100 mg/dL

(See http://www.americanheart.org/presenter.jhtml?identifier=534). Accordingly, control and improvement of these and related metabolic risk factors prevent the onset and treat Syndrome X. The AHA has indicated that to gain the most benefit from modifying multiple metabolic risk factors that cause Syndrome X, the underlying insulin resistant state must become a target of therapy and that the safest, most effective and preferred way to reduce insulin resistance in overweight and obese people is through weight loss increased physical activity. The AHA has also indicated that the following steps are also important for managing Syndrome X:
1. Routinely monitoring body weight (especially the index for central obesity), blood glucose, lipoproteins and blood pressure.
2. Treating individual risk factors (hyperlipidemia, hypertension and high blood glucose) according to established guidelines.
3. Carefully choosing anti-hypertensive drugs because different agents have different effects on insulin sensitivity.

(See http://www.americanheart.org/presenter.jhtml?identifier=534). Accordingly, improving and thereby eliminating these and other related metabolic risk factors that cause Syndrome X, is an effective way of preventing, treating, and controlling the progression of Syndrome X.

A related condition that effects most Americans is cardiovascular disease. In fact, cardiovascular disorders are the number one killer of both men and women in the United States. Coronary heart disease is so prevalent that it is estimated that one in five Americans have some form of it. It is also estimated that as many as 1.1 million Americans will have a coronary attack this year and about one-third of them will die from that attack.

The AHA has acknowledged that common cardiovascular risk factors for coronary heart disease and stroke that can be controlled or treated include high total cholesterol (240 mg/dL or higher), triglyceride levels (blood fats, 150 mg/dL or higher), high LDL cholesterol levels (greater than 100 mg/dL), low HDL cholesterol levels (less than 40 mg/dL for men; less than 50 mg/dL for women), high blood pressure (135.85 mm/Hg or higher), smoking, diabetes, physical inactivity, and being overweight (BMI of 25.1 to 30.0) or obese (BMI of 30.0 or greater). (See http://strokeassociation.org/presenter.jhtml?identifier=3027394 & http://strokeassociation.org/presenter.jhtml?identifier=4716 which are incorporated herein by reference). It is well accepted that these cardiovascular risk factors cause a variety of ailments, including cardiovascular disease and death. Accordingly, in an effort to prevent or treat these ailments and prolong life, improvement and elimination of these and related cardiovascular risk factors is highly desirable.

Various treatments have been created to target improvement or elimination of the treatable cardiovascular risk factors that cause various coronary ailments and the metabolic risk factors that cause Syndrome X. Unfortunately, none of these treatments have been shown to be particularly effective at improving or eliminating either the cardiovascular rick factors (elevated total cholesterol, triglyceride, LDL cholesterol, blood pressure, reduced HDL cholesterol, diabetes and being overweight or obese) or the metabolic risk factors (obesity, elevated triglycerides, fasting glucose levels and blood pressure, and reduced HDL) that cause Syndrome X to such a degree that they are significantly improved or eliminated and, in the case of the metabolic risk factors, Syndrome X is prevented or treated. Additionally, the known treatments can be difficult to administer, cause serious and undesirable side effects and often become less and less effective over time.

Additionally, it is a well know fact that the incidence of obesity in adults as well as children, a known risk factor that causes Syndrome X, is increasingly globally. Once considered a problem of developed countries, this global epidemic also affects developing countries. Coupled with this epidemic are obesity-related complications such as cardiovascular disease, stroke, depression, and Type-2 diabetes, all of which are spreading rapidly across poor and middle-income countries, where infectious diseases and malnutrition have previously overshadowed such illnesses. In Cameroon, Africa about 25% of the adult population is either overweight or obese. This figure, though alarming, has followed a similar trend to Europe and the United States, where there has been a consistent increase in the past 20 years. In 1991, four states in the United States had obesity prevalence rates of 15-19% and none had rates above 20%. In 2004, seven states had obesity prevalence rates of 15-19%, 33 states had rates of 20-24%, and nine states had rates more that 25%.

Associations between obesity and high blood pressure, high blood pressure, high blood cholesterol, and low levels of high densisty lipoprotein-cholesterol (HDL-C) have been shown in men and women in diverse race/ethnic groups. Associations have also been reported between obesity and high fasting blood glucose levels. This perturbation of blood lipid components as well as blood glucose levels is referred to by some as Syndrome X.

A number of anorexiant pharmacological agents, such as sibutramine, enhance satiation by blocking the reuptake of monoamine neurotransmitters (serotonin, norepinephrine, and to a lesser extent, dopamine) in the hypothalamus. Blocking monoamine reuptake increases the signal transmitted to the postsynaptic nerve resulting in satiation or satiety. Another common pharmacological mode used to treat obesity employs drugs designed to block the absorption of dietary fat, such as orlistat. Orlistat binds to gastric, pancreatic, and carboxyl-ester lipases in the gut lumen and blocks the digestion of dietary fat by preventing lipase from interacting with its lipid target. Among other drawbacks, the inhibition of fat digestion decreases mixed micelle formation and absorption of long-chain fatty acids, cholesterol, and certain fat-soluble vitamins.

The above pharmacological therapies in combination with dietary regimes have been used in obese patients to produce weight loss and attempt to reverse the accompanying complications and conditions that are associated with them. Unfortunately, these methods are not only compromised by potential safety issues, which has sometimes led to their removal from the market, the often are not very effective, lose their effectiveness over time, can cause numerous undesirable side effects and complications that are expensive.

Accordingly, compositions and related methods that improve or eliminate well known cardiovascular rick factors and the metabolic risk factors that cause Syndrome X are needed. Additionally, compositions and related methods that provide additional health benefits, including but not limited to, reducing weight (by reducing mostly body fat), total cholesterol, LDL cholesterol, triglyceride, and fasting blood glucose levels and increasing HDL or good cholesterol and serum serotonin levels are also needed. The present invention provides these and other related benefits and advantages.

### SUMMARY OF THE INVENTION

Briefly, and in general terms, the present invention resides in products and related methods using an effective amount of soy albumin to provide a variety of health-related benefits to a mammal. More specifically, in the present invention resides using and effective amount of soy albumin 1) reduce weight and decrease BMI, 2) reduce total cholesterol levels, 3) reduce LDL cholesterol levels, 4) increase HDL or good cholesterol levels, 5) improve the total cholesterol/HDL ratio, 6) improve LDL/HDL ratio, 7) reduce triglyceride levels, 8) increase serum serotonin levels, 9) decrease fasting blood glucose levels and 10) prevent, improve or treat Syndrome X or the cardiovascular or metabolic factors that cause Syndrome X in mammals.

Additionally, by way of example and not limitation, in one exemplary embodiment, a product for reducing weight in a mammal is provides. The products contains and effective amount of soy albumin that causes a mammal that consumes it to loose weight.

In another exemplary embodiment of the present invention, a product for improving at least one health-related factor in a mammal is provided. The product contains an effective amount of soy albumin such that consumption of the product containing an effective amount of soy albumin by a mammal results in one or more health-related benefits, including weight loss, lowered BMI, reduced total cholesterol levels, reduced LDL cholesterol levels, increased HDL or good cholesterol levels, improved total cholesterol/HDL ratio, improved LDL/HDL ratio, reduced triglyceride levels, increased serum serotonin levels and/or decreased fasting blood glucose levels.

In yet another exemplary embodiment of the present invention, a product for improving at least one health-related factors in a mammal is provided. The product contains and effective amount of soy albumin such that consumption of the product containing and effective amount of soy albumin by a mammal results in weight loss, lowered BMI, reduced total cholesterol levels, reduced LDL cholesterol levels, increased HDL or good cholesterol levels, improved total cholesterol/HDL ratio, improved LDL/HDL ratio, reduced triglyceride levels, increased serum serotonin levels and decreased fasting blood glucose levels.

In yet another exemplary embodiment of the present invention, a method for providing health-related benefits to a mammal is provided. The method includes but is not limited to, providing a product containing an effective amount of soy albumin to a mammal and claiming that the product provides any combination of health-related benefits, including but not limited to, weight loss, lowering or improving BMI, reducing or improving total cholesterol levels, reducing or improving LDL cholesterol levels, increasing or improving HDL or good cholesterol levels, improving total cholesterol/HDL ratio, improving LDL/HDL ratio, reducing or improving triglyceride levels, increasing or improving serum serotonin levels, decreasing or improving fasting blood glucose levels and preventing, improving or treating Syndrome X or the cardiovascular or metabolic factors that cause Syndrome X.

In an aspect of at least one exemplary embodiment of the present invention, the effective amount of soy albumin provided to the mammal is 50 mg to 3000 mg.

In another aspect of at least one exemplary embodiment of the present invention, effective amount of the soy albumin provided to the mammal is 300 mg to 3000 mg of soy albumin daily and the soy albumin is not roasted.

In yet another aspect of at least one exemplary embodiment of the present invention, the effective amount of soy albumin provides the mammal with 100 mg to 500 mg of soy albumin daily and the soy albumin is not roasted.

In yet another aspect of at least one exemplary embodiment of the present invention, the effective amount of soy albumin in 100 mg to 6000 mg of soy albumin to the mammal and the product further includes and effective amount of fenugreek, phaseolamine, and/or bicarbonate.

In yet another aspect of at least one exemplary embodiment of the present invention, the effective amount of soy albumin is 100 mg to 6000 mg of soy albumin to the mammal and the product further includes an effective amount of fenugreek and phaseolamine.

In yet another aspect of at least one exemplary embodiment of the present invention, the effective amount of soy albumin is 100 mg to 6000 mg of soy albumin to the mammal and the product further includes and effective amount of fenugreek and bicarbonate.

In yet another aspect of at least one exemplary embodiment of the present invention, the effective amount of soy albumin is 100 mg to 6000 mg of soy albumin to the mammal and the product further includes an effective amount of phaseolamine and bicarbonate.

In yet another aspect of at least one exemplary embodiment of the present invention, the effective amount of fenugreek provides 2 g to 8 g of fenugreek to the mammal daily, the effective amount of phaseolamine provides 0.1 to 1.0 g phaseolamine to the mammal daily and the effective amount of bicarbonate provides 0.1 g to 1.0 g of bicarbonate to the mammal daily and the product is provided as part of a bar, powder or capsule.

In yet another aspect of the present invention, different types and amounts of soy albumin, which include both those disclosed herein and those that are commercially available, are combines to provide a product or products that provide results that are most desirable to the individual purchasing or consuming the product.

### BRIEF DESCRIPTION OF THE DRAWINGS

FIG. 1 shows a chart which summarizes the results of a series of experiments demonstrating the effect of eight weeks of supplementation with the different types and amounts of soy albumin on a variety of health-related factors including weight loss, total cholesterol, LDL cholesterol levels, HDL or good cholesterol levels, triglyceride levels, serum serotonin levels and fasting blood glucose levels.

FIG. 2 shows a bar graph which summarizes the results of experiments of demonstrating that eight weeks of supplementation with different types and amounts of soy albumin caused significant and unexpected weight loss in members in a group of forty five moderately obese human subjects when compared to the control group (placebo).

FIG. 3 shows a bar graph which summarizes the results of experiments demonstrating that eight weeks of supplementation with different types and amounts of soy albumin caused a significant and unexpected decrease in the percentage of total cholesterol in members in a group of forty five moderately obese human subjects when compared to the control group (placebo).

FIG. 4 shows a bar graph which summarizes the results of experiments demonstrating that eight weeks of supplementation with different types and amounts of soy albumin caused a significant and unexpected decrease in the percentage of LDL cholesterol in members in a group of forty five moderately obese human subjects when compared to the control group (placebo).

FIG. 5 shows a bar graph which summarizes the results of experiments demonstrating that eight weeks of supplementation with different types and amounts of soy albumin caused a significant and unexpected increase in the percentage of HDL or “good” cholesterol in members in a group of forty five moderately obese human subjects when compared to the control group (placebo).

FIG. 6 shows a bar graph which summarizes the results of experiments demonstrating that eight weeks of supplementation with different types and amounts of soy albumin caused a significant and unexpected decrease in the percentage of triglycerides in members in a group of forty five moderately obese human subjects when compared to the control group (placebo).

FIG. 7 shows a bar graph which summarizes the results of experiments demonstrating that eight weeks of supplementation with different types and amounts of soy albumin caused a significant and unexpected increase in the percentage of serum serotonin in members in a group of forty five moderately obese human subjects when compared to the control group (placebo).

FIG. 8 shows a bar graph which summarizes the results of experiments demonstrating that eight weeks of supplementation with different types and amounts of soy albumin caused a significant and unexpected decrease in the percentage of fasting blood glucose in members in a group of forty five moderately obese human subjects when compared to the control group (placebo).

FIG. 9 shows a chart which summarizes the results of a series of experiments demonstrating the effect of eight weeks of supplementation with different types and amounts of soy albumin alone and in combination with different combinations of fenugreek, phaseolamine and bicarbonate, provided as a bar (biscuit), on a variety of health-related factors including weight loss, total cholesterol, LDL cholesterol levels, HDL or good cholesterol levels, triglyceride levels, serum serotonin levels and fasting blood glucose levels.

FIG. 10 shows a bar graph which summarizes the results of experiments demonstrating that eight weeks of supplementation with different types of bars (biscuits) containing different amounts and types of soy albumin alone and in combination with different combinations of fenugreek (Fen), phaseolamine (Ph), or bicarbonate (Bi), caused significant and unexpected weight loss in members of a group of one hundred and ten moderately obese human subjects when compared to the control (placebo).

FIG. 11 shows a bar graph which summarizes the results of experiments demonstrating that eight weeks of supplementation with different types of bars (biscuits) containing different amounts and types of soy albumin alone and in combination with different combinations of fenugreek (Fen), phaseolamine (Ph), or bicarbonate (Bi), caused a significant and unexpected decrease in the percentage of total cholesterol in members of a group of one hundred and ten moderately obese human subjects when compared to the control group (placebo).

FIG. 12 shows a bar graph which summarizes the results of experiments demonstrating that eight weeks of supplementation with different types of bars (biscuits) containing different amounts and types of soy albumin alone and in combination with different combinations of fenugreek (Fen), phaseolamine (Ph), or bicarbonate (Bi), caused a significant and unexpected decrease in the percentage of LDL cholesterol in members of a group of one hundred and ten moderately obese human subjects when compared to the control group (placebo).

FIG. 13 shows a bar graph which summarizes the results of experiments demonstrating that eight weeks if supplementation with different types of bars (biscuits) containing different amounts and types of soy albumin alone and in combination with different combinations of fenugreek (Fen), phaseolamine (Ph) or bicarbonate (Bi), caused a significant and unexpected increase in the percentage of HDL cholesterol in members of a group of one hundred and ten moderately obese human subjects when compared to the control group (placebo).

FIG. 14 shows a bar graph which summarizes the results of experiments demonstrating that eight weeks of supplementation with different types of bars (biscuits) containing different amounts and types of soy albumin alone and in combination with different combinations of fenugreek (Fen), phaseolamine (Ph) or bicarbonate (Bi), caused a significant and unexpected decrease in the percentage of triglycerides in members of a group of one hundred and ten moderately obese human subjects when compared to the control group (placebo).

FIG. 15 shows a bar graph which summarizes the results of experiments demonstrating that eight weeks of supplementation with different types of bars (biscuits) containing different amounts and types of soy albumin alone and in combination with different combinations of fenugreek (Fen), phaseolamine (Ph) or bicarbonate (Bi), caused a significant and unexpected increase in the percentage of serum serotonin in members of a group if one hundred and ten moderately obese human subjects when compared to the control group (placebo).

FIG. 16 shows a bar graph which summarizes the results of experiments demonstrating that eight weeks of supplementation with different types of bars (biscuits) containing different amounts of types of soy albumin alone and in combination with different combinations of fenugreek (Fen), phaseolamine (Ph) or bicarbonate (Bi), caused a significant and unexpected decrease in the percentage of fasting blood glucose in members of a group of one hundred and ten moderately obese human subjects when compared to the control group (placebo).

FIG. 17 shows a flowchart demonstrating one exemplary method for obtaining soy albumin.

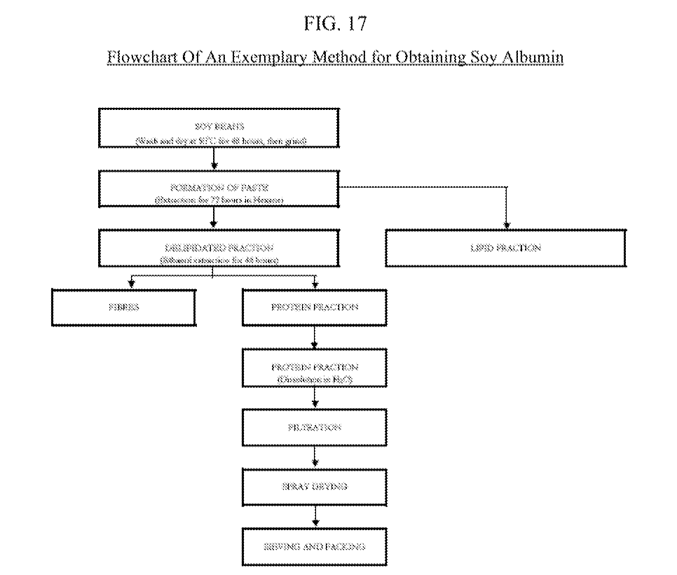

### DETAILED DESCRIPTION OF THE PREFERRED EMBODIMENTS

Briefly, and in general terms, the present disclosure is directed to providing compositions and related methods using soy albumin to improving a wide variety of health-related factors. More specifically, the present disclosure relates to using soy albumin to achieve 1) weight loss and decreased BMI, 2) reduced total cholesterol levels, 3) reduced LDL cholesterol levels, 4) increased HDL or “good” cholesterol levels, 5) improved total cholesterol/HDL ratio, 6) improved LDL/HDL ratio, reduced triglyceride levels, 7) increased serum serotonin levels, 8) decreased fasting blood glucose levels and 9) prevention, improvement or treatment of Syndrome X or the cardiovascular or metabolic factors that cause Syndrome X in mammals.

In order to rest and validate the efficacy of the products and related methods disclosed in the present disclosure, a variety of university conducted and controlled experiments were performed to measure the effects if different amounts and types of soy albumin on a variety of health-related factors. All the experiments were conducted at the University of Yaounde I, Cameroon, Department of Biochemistry. The soy albumin (AlbumaSoy™) was obtained from Soy Labs in California, United States. The experiments were all randomized double-blind, placebo controlled studies. The soy albumin used in all the experiments described herein had the characteristics show Table 1.

TABLE 1
Descrption of AlbumaSoy
Extract of Glycine max (soy beans) standardized to NLT 8%
soy albumins in a medium mesh powder
SPECIFICATIONS

| | |
|---|---|
| Chemical Classification | Organic, Nutritive |
| Physical Classification | Powder, Non Fibrous |
| Genus, species | Glycine max |
| Plant Part | Bean (kernel) |
| Color | Brown |
| Odor | Characteristic Herbal |
| Taste | Bitter |
| Loss on Drying | Less than 6% |
| Solubility (water) | Partly Soluble |
| pH (1 g/100 ml water) | 4.0–6.5 |
| Solvents Used | Water |
| Active Ingredients: | |
| Soy Albumin (%) | 8–30 |
| Total Protein (%) | 10–50 |
| Heavy Metals: | |
| Total (ppm) | Less than 20 |
| Particle Size | 98% thru # 40 Mesh |
| Bulk Density (g/cc) | NLT 0.3 |
| Microbiological Assays: | |
| Total Plate Count (CFU/g) | Less than 3000 |
| Yeast and Mold (CFU/g) | Less than 100 |
| E. Coli (CFU/g) | Negative |
| Salmonella (CFU/g) | Negative |
| Staph. aureus (CFU/g) | Negative |
| Pseudomonas | Negative |
| Country of Origin | India |
| Shelf Life | 2 years when stored in tightly |
| | closed dark containers in a |
| | cool dry location. Limit |
| | exposure to air. |

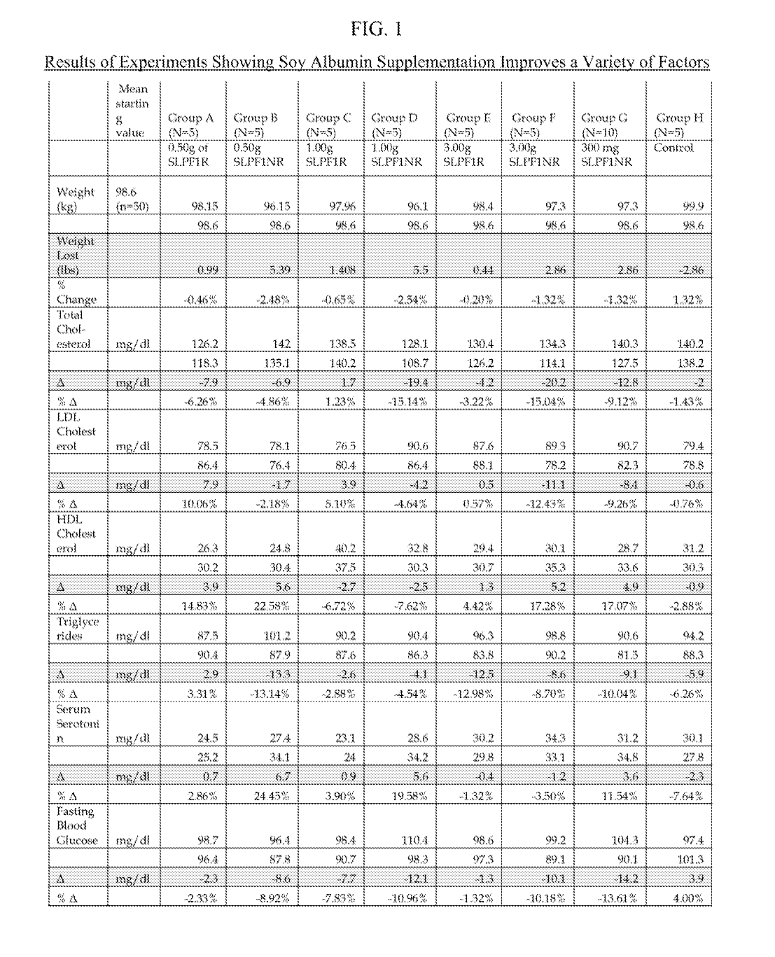

The first set of experiments tested the effects of different types and amounts of soy albumin, provided in capsule form, on body weight and BMI. % change in total cholesterol, LDL cholesterol, HDL cholesterol, triglycerides, fasting blood glucose and serum serotonin levels of forty five mildly obese humans (See FIG. 1 for a summary of the results of those experiment).

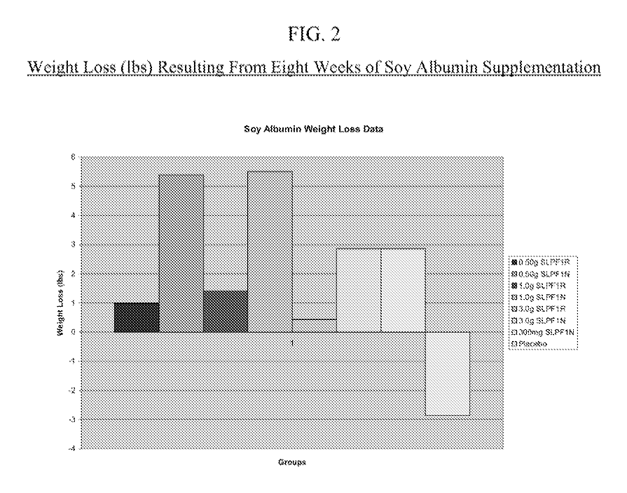

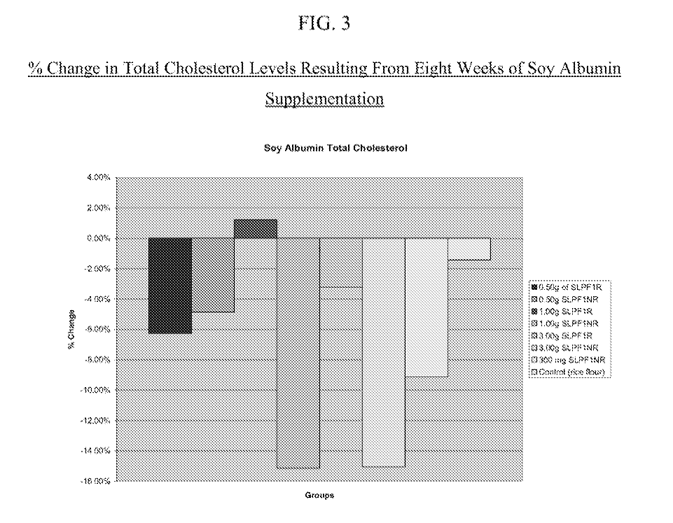

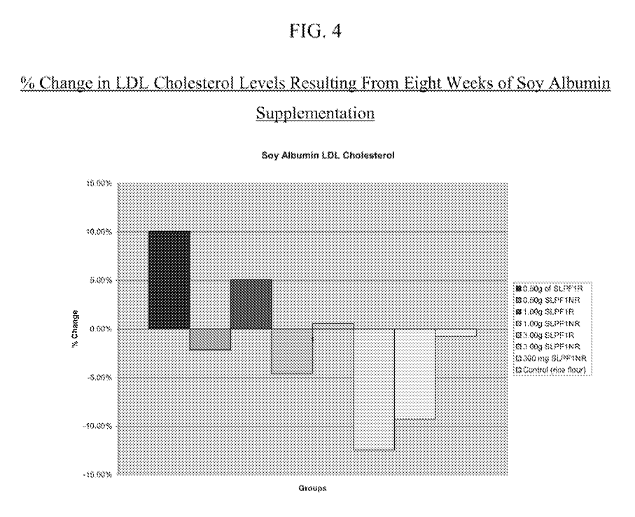

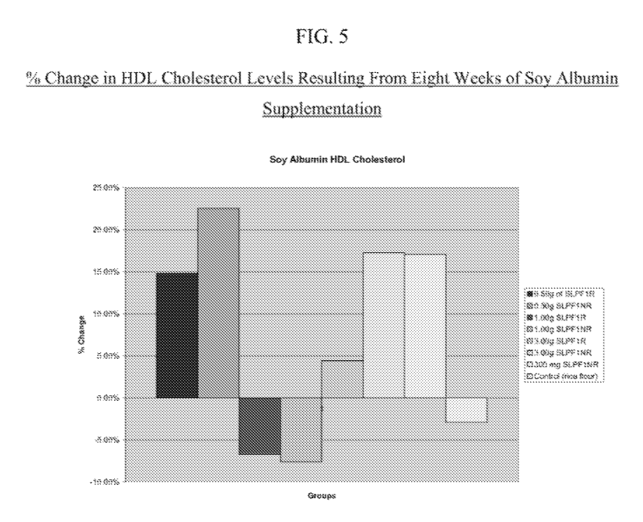

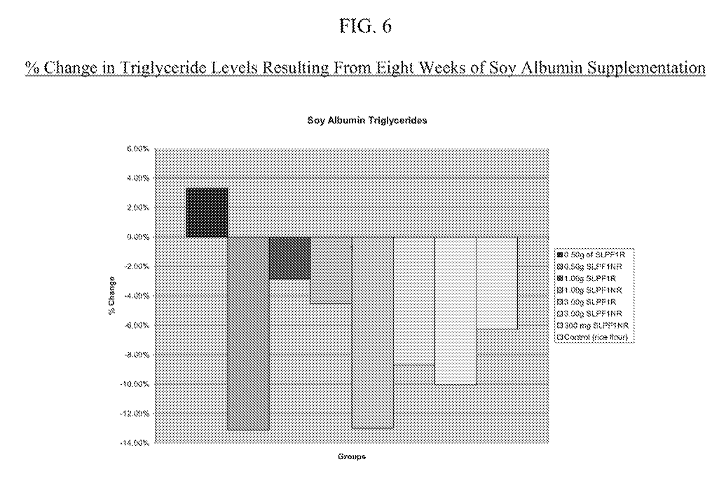

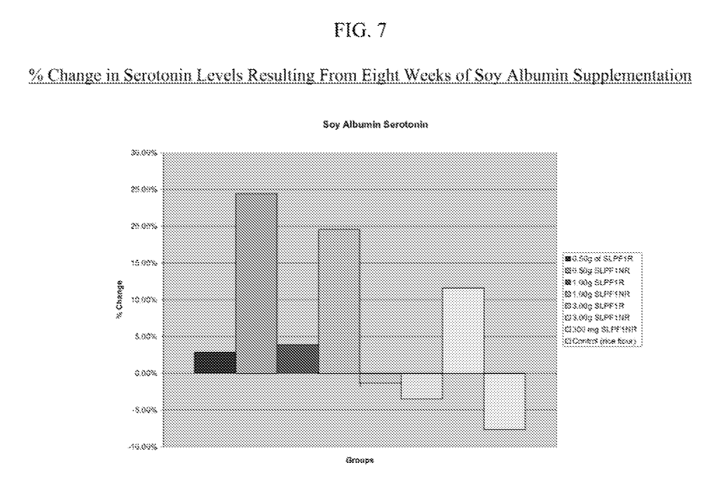

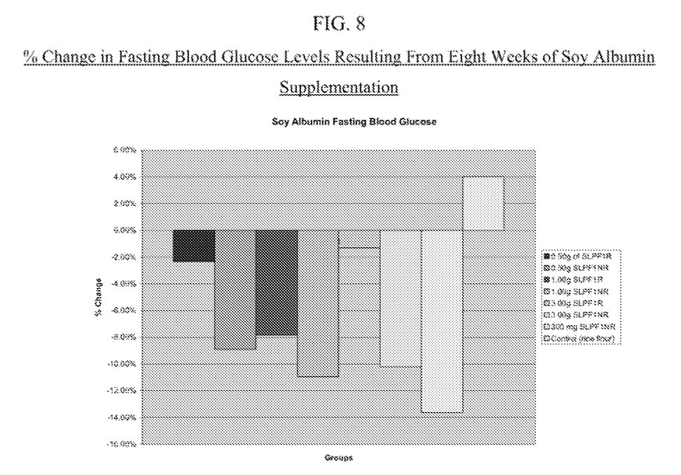

Participants in the study were moderately obese male and female human subjects who participated voluntarily. The purpose, nature, and potential risks of the study were explained to all participants, who gave written informed consent before participation. The study was conducted in accordance with the Helsinki Declaration (1983 version). The participants diets were not monitored or controlled in any way but they were asked to eat sensibly. Mild exercise was recommended but not monitored. 300 mgs-3000 mgs soy albumin (AlbumaSoy™) was administered to the participants not on the control group in two equally divided doses (morning and evening) for eight weeks. The soy albumin was either Soy Labs protein fraction roasted (SLPF1R) or Soy Labs protein faction non-roasted (SLPF1NR). The protein fraction used from SLPF was the albumin fraction, which was obtained by aqueous extraction. The exact amounts and types of soy albumin administered as described in Table 1 and FIGS. 1-8.

TABLE 2

| | | | No. of |
|---|---|---|---|
| Group No. | Participants | Treatment | Participants |
| A | Males/Females | 0.50 grams of SLPF1R | 5 |
| B | Males/Females | 0.50 grams of SLPF1NR | 5 |
| C | Males/Females | 1.0 grams of SLPFIR | 5 |
| D | Males/Females | 1.0 grams of SLPFINR | 5 |
| E | Males/Females | 3.0 grams of SLPFIR | 5 |
| F | Males/Females | 3.0 grams of SLPFINR | 5 |
| G | Males/Females | 300 milligrams of SLPFINR | 10 |
| H | Males/Females | Placebo (rice flour) | 5 |
| | | | Total = 45 |

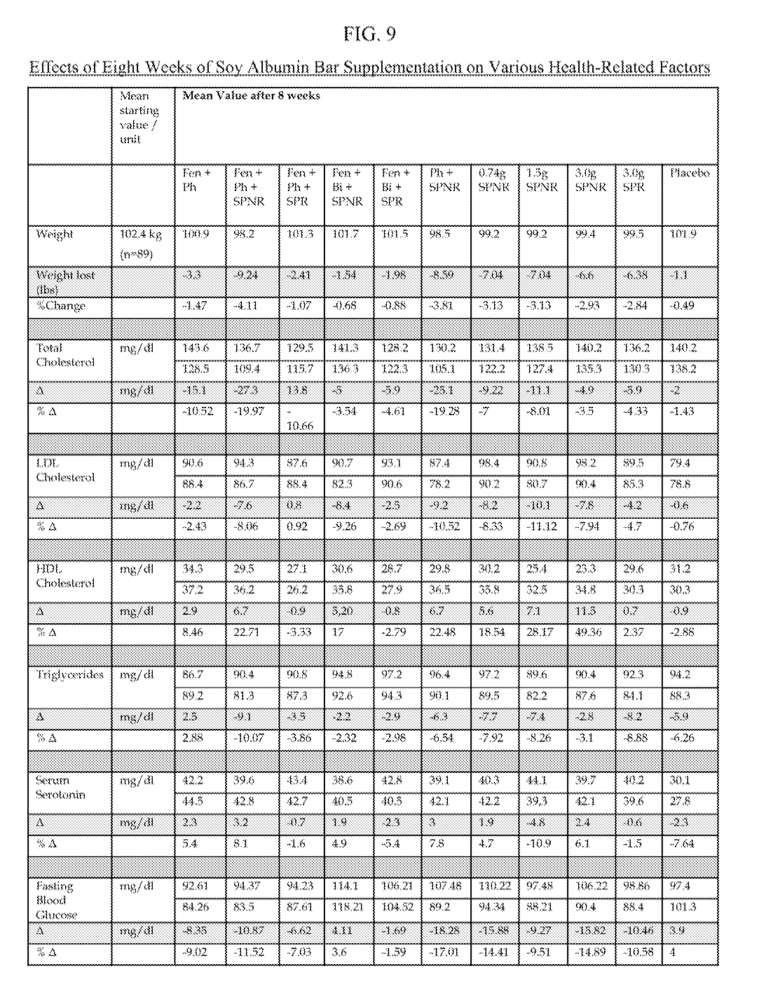

The second set of experiments tested the effects of different types and amounts of soy albumin, provided in a bar (e.g., biscuit), alone and in combination with different combinations of fenugreek (Fen), phaseolamine (Ph) or bicarbonate (Bi), on body weight and BMI, % change in total cholesterol, LDL cholesterol, HDL cholesterol, triglycerides, fasting blood glucose and serum serotonin levels (See FIG. 9 for a summary of the results of those experiment).

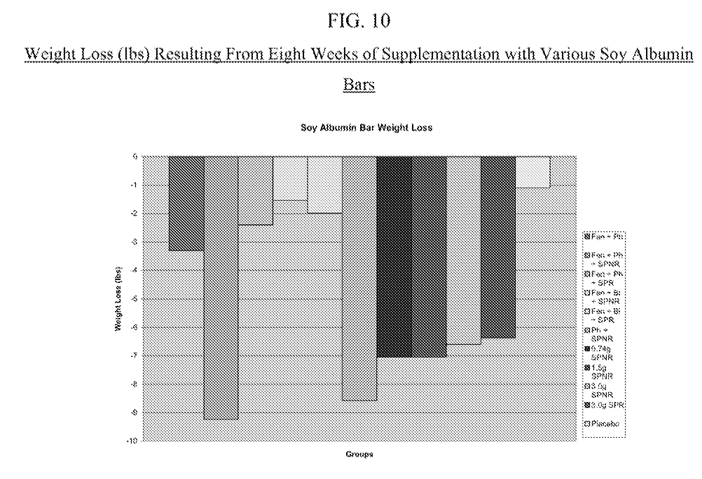

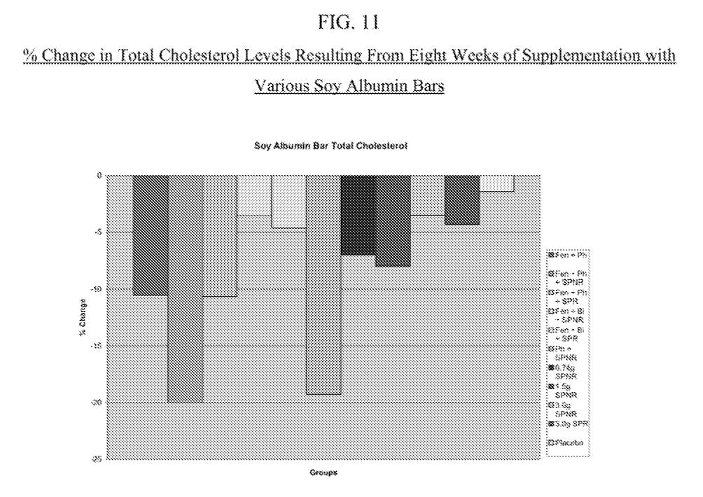

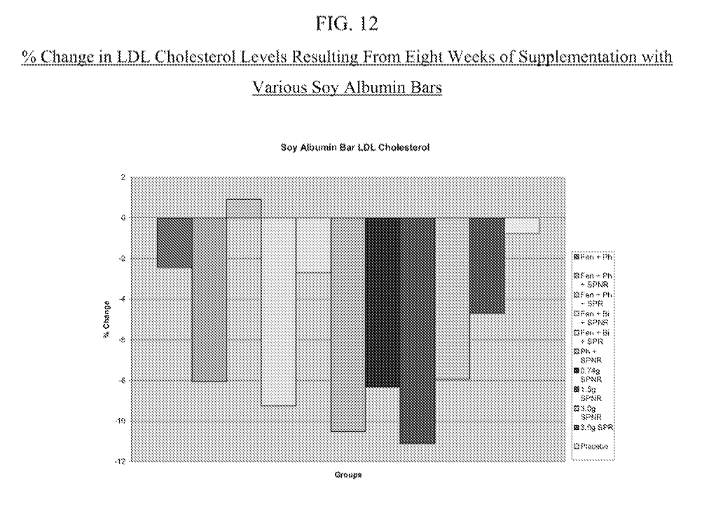

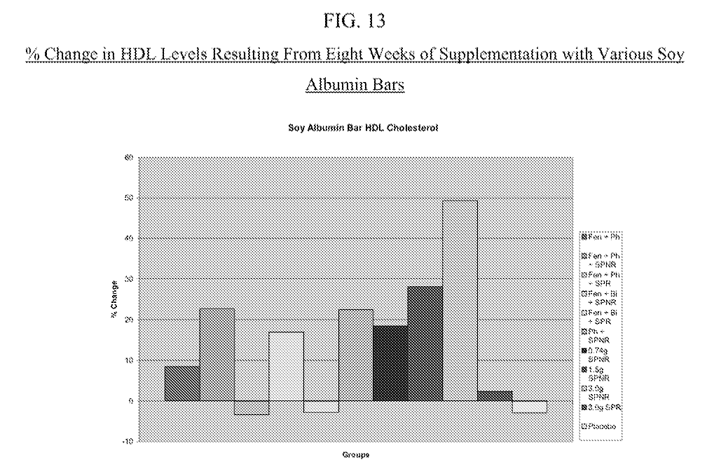

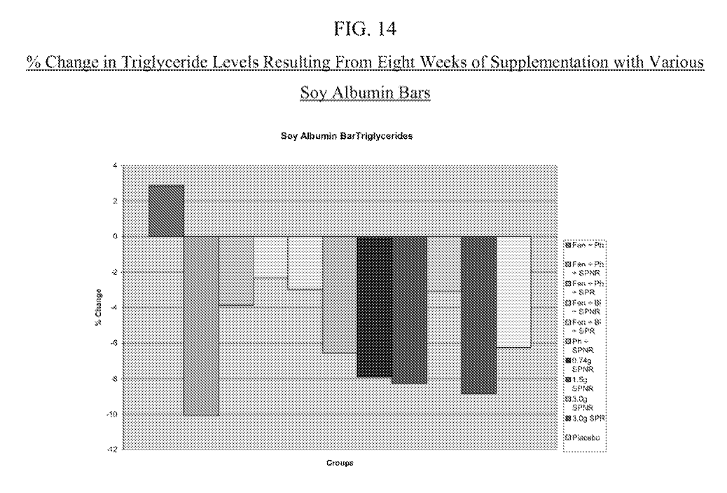

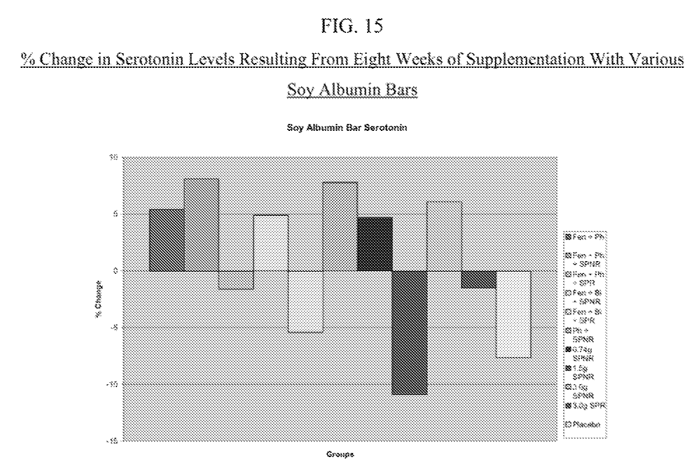

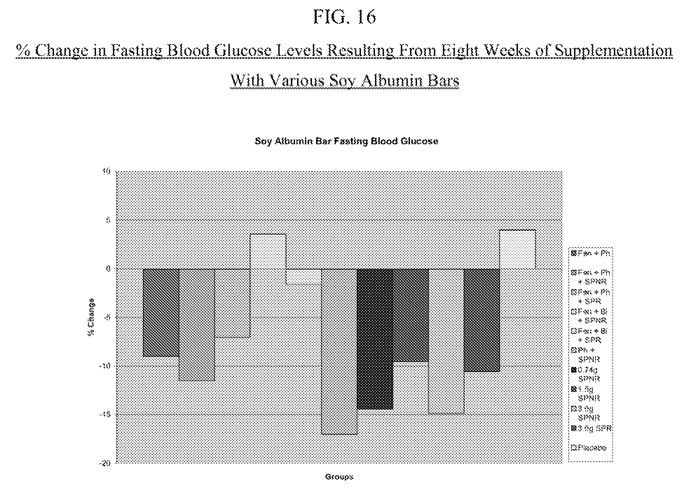

Participants in the study were once again obese male and female subjects who participated voluntarily. The purpose, nature, and potential risks of the study were explained to all participants, who gave written informed consent before participation. The study was conducted in accordance with the Helsinki Declaration (1983 ) version. The participants diets were not monitored or controlled in any way but they were asked to eat sensibly. Mild exercise was recommended but not monitored. 0.74-3.0 grams soy albumin (AlbumaSoy™) was administered, with and without different combinations of fenugreek (Fen), phaseolamine (Ph) or bicarbonate (Bi), to the participants not in the control group in two equally divided doses (morning and evening) for eight weeks. The soy albumin was either Soy Labs protein fraction roasted (SLPF1R) or Soy Labs protein faction non-roasted (SLPF1NR). The protein fraction used from SLPF was the albumin fraction, which was obtained by aqueous extraction. The exact groups and the soy albumin product or formulation that was administered to the participants is described in Table 2 and FIGS. 9-16.

TABLE 2

| Group No. | Participants | Treatment | Participants |
|---|---|---|---|
| 1 | Males/Females | 3 grams fenugreek + 0.2grams | 10 |
| | | phaseolamine (Twice Daily) | |
| 2 | Males/Females | 3 grams fenugreek + 0.2 grams | 10 |
| | | phaseolamine + 0.74 grams SLPF1NR (Twice | |
| | | Daily) | |
| 3 | Males/Females | 3 grams fenugreek + 0.2 grams | 10 |
| | | phaseolamine + 0.74 grams SLPFIR | |
| | | (Twice Daily) | |
| 4 | Males/Females | 3 grams fenugreek + 0.2 grams | 10 |
| | | bicarbonate + 0.74 grams SLPF1NR | |
| | | (Twice Daily) | |
| 5 | Males/Females | 3 grams fenugreek + 0.2 grams | 10 |
| | | bicarbonate + 0.74 grams SLPF1R | |
| | | (Twice Daily) | |
| 6 | Males/Females | 0.2 grams phaseolamine + 0.74 grams | 10 |
| | | SLPF1NR (Twice Daily) | |
| 7 | Males/Females | 0.74 grams SLPFINR (Twice Daily) | 10 |
| 8 | Males/Females | 1.5 grams SLPF1NR (Twice Daily) | 10 |
| 9 | Males/Females | 3.0 grams SLPF1NR (Twice Daily) | 10 |
| 10 | Males/Females | 3.0 grams SLPF1R (Twice Daily) | 10 |
| 11 | Males/Females | Placebo (Twice Daily) | 10 |
| | | | Total = 110 |

Experimental Protocol

The study was a randomized, double blind placebo-controlled design consisting of an eight week period. Participants received two doses daily of the capsule or placebo or biscuit or placebo for a total of eight weeks.

The capsules and biscuits were identical in shape color and appearance with their placebo counterparts, with neither the participants not the researcher administering them knowing which capsule each participant received. Participants were asked about side effects during each return visit.

Body weight loss was determined using a Tanita™ scale. All anthropometric measurements were taken at the start of the test period and on a weekly basis. Blood samples were collected after a twelve hour overnight fast, into heparinized tubes. The concentrations of total cholesterol, triglycerides, HDL-cholesterol, LDL-cholesterol and fasting blood glucose were measured using commercial diagnostic kits (cholesterol Infinity, triglyceride Infinity, EZ HDL™ cholesterol, EZ LDL™ cholesterol, Glucose Trinder) from SIGMA Diagnostics. Serotonin was measured using an enzyme immunoassay method (Serotonin EIA kit, BioSource Europe S.A. Belgium).

Spectrophotometeric Determination of Soy Albumin

The following describes how the we determined how much soy albumin was present. Albumin forms Greenish blue complex with bromocresol green 4.2 pH, which is measured at 510 nm

The following reagents were used:
1) BUFFER PH 4.2 SOLUTION: 19.2 gms of Citric reagent grade was dissolved in 500 ml of DM water and PH adjusted to 4.2 using 1N NaOH and made up to 1000 ml.
2) 5% STD BOVINE ALBUMIN SOLUTION: 5 gms of Albumin (Standard Bovine Albumin from National Biochemical corporation Cleveland USA assay 99% +) was placed in a 100 ml standard flask, we added 25 ml of 4.2 PH buffer Solution, dissolved & made up to 100 ml using 4.2 PH buffer. The reagent was ready to use and stable when stored at 5° C.
3) BROMOCRESOL GREEN SOLUTION: Std 41.9 mgms of bromocresolgreen indicator is dissolved in 1 ml of 0.1 N NaOH & made up to 100 ml using D.M. Water. 10 ml of the above solution was diluted with 30 ml of PH 4.2 buffer and PH adjusted to 4.2.

Standard Measurement

In a test tube we took 5 ml of bromocresolgreen 4.2 PH solution. Added 25 μl of 5% STD Albumin solution, shook the test tube for 10 mins & measured the OD at 510 nm using bromocresolgreen 4.2 PH solution as the blank. We zeroed the blank before measurement of the STD.

Sample Measurement:

In a centrifuge tube we took 1 gm of the Soy albumin extract powder and added 5 ml of PH 4.2 Buffer. We sonicated for 10 mins & centrifuge. We filtered the supernatant through Watmann 41 filter paper. We then took 125 μl of the filtrate (Instead of 25 μl due to the 5 times dilution) and added it to 5 ml of bromocresolgreen 4.2 PH buffer. We mixed for 10 minutes and measured the OD at 510 nm using bromocresol green PH 4.2 solution (Zeroed reagent) as blank

A simple calculation of and of spl/abs of standard X weight of standard/weight of SPL gave us the % Albumin in SAMPLE

Selected Results & Discussions

FIGS. 1-16 demonstrate how the various different types and amounts of soy albumin, in capsules and bars and with and without other ingredients individually effected the 1) weight, 2) total cholesterol, 3) LDL cholesterol, 4) HDL or “good” cholesterol, 5) triglyceride levels, 6) serum serotonin levels and 7) fasting blood glucose levels of the participants. As discussed above, these and other health-related factors play a major role in the onset, progression and treatment of Syndrome X. Accordingly, prevention and treatment of these factors allows treatment and prevention of Syndrome X.

The results from these experiments show that an effective amount of soy albumin, which was well tolerated by the participants, can be effectively used to improve the numerous health-related factors tested and disclosed herein. Importantly, an effective amount of soy albumin can significantly reduced body weight as well as body fat. These two factors contribute significantly to the complications associated with being overweight or obese, and are well known risk factors for Syndrome X. Accordingly, it should be appreciated that the present invention can be used to prevent, control, treat or improve Syndrome X and the underlying factors that cause it.

Accordingly, by the way of example and not limitation, in one exemplary embodiment of the present invention, a product for reducing weight in a mammal is provided. The products contains and effective amount of soy albumin that causes a mammal that consumes it to loose weight.

In another exemplary embodiment of the present invention, a product for improving at least one health-related factors in a mammal is provided. The product contains an effective amount of soy albumin such that consumption of the product containing an effective amount of soy albumin by a mammal results in one or more health-related benefits, including weight loss, lowered BMI, reduced total cholesterol levels, reduced LDL cholesterol levels, increased HDL or good cholesterol levels, improved total cholesterol/HDL ratio, improved LDL/HDL ratio, reduced triglyceride levels, increased serum serotonin levels and/or decreased fasting blood glucose levels.

In another exemplary embodiment of the present invention, a product for improving at least one health-related factors in a mammal is provided. The product contains and effective amount of soy albumin such that consumption of the product containing and effective amount of soy albumin by a mammal results in weight loss, lowered BMI, reduced total cholesterol levels, reduced LDL cholesterol levels, increased HDL or good cholesterol levels, improved total cholesterol/HDL ratio, improved LDL/HDL ratio, reduced triglyceride levels, increased serum serotonin levels and decreased fasting blood glucose levels.

In yet another exemplary embodiment of the present invention, a method for providing health-related benefits to a mammal is provided. The method includes but is not limited to, providing a product containing an effective amount of soy albumin to a mammal and claiming that the product provides any combination of health-related benefits, including but not limited to, weight loss, lowering or improving BMI, reducing or improving total cholesterol levels, reducing or improving LDL cholesterol levels, increasing or improving HDL or good cholesterol levels, improving total cholesterol/HDL ratio, improving LDL/HDL ratio, reducing or improving triglyceride levels, increasing or improving serum serotonin levels, decreasing or improving fasting blood glucose levels and preventing, improving or treating Syndrome X or the cardiovascular or metabolic factors that cause Syndrome X.

In an aspect of at least one exemplary embodiment of the present invention, the effective amount of the soy albumin provided to the mammal is 50 mg to 3000 mg.

In another aspect of at least one exemplary embodiment of the present invention, the effective amount of the soy albumin provided to the mammal is 300 mg to 3000 of soy albumin daily.

In yet another aspect of at least one exemplary embodiment of the present invention, the effective amount of the soy albumin provides the mammal with 100 mg to 500 mg of soy albumin daily and the albumin is not roasted.

In yet another aspect of at least one exemplary embodiment of the present invention, the effective amount of soy albumin 100 mg to 6000 mg of soy albumin to the mammal and the product further includes and effective amount of fenugreek, phaseolamine, and/or bicarbonate.

In yet another aspect of at least one exemplary embodiment of the present invention, the effective amount of soy albumin is 100 mg to 6000 mg of soy albumin to the mammal and the product further includes and effective amount of fenugreek and phaseolamine.

In yet another aspect of at least one exemplary embodiment of the present invention, the effective amount of soy albumin is 100 mg to 6000 mg of soy albumin to the mammal and the product further includes an effective amount of fenugreek and bicarbonate.

In yet another aspect of at least one exemplary embodiment of the present invention, the effective amount of soy albumin is 100 mg to 6000 mg of soy albumin to the mammal and the product further includes an effective amount of phaseolamine and bicarbonate.

In yet another aspect of at least one exemplary embodiment of the present invention, the effective amount of fenugreek provides 2 g to 8 g of fenugreek to the mammal daily, the effective amount of phaseolamine provides 0.1 g to 1.0 g phaseolamine to the mammal daily and the effective amount of bicarbonate provides 0.1 g to 1.0 of bicarbonate to the mammal daily and the product is provided as part of a bar, powder or capsule.

In yet another aspect of the present invention, different types and amounts of soy albumin, which include both those disclosed herein and those that are commercially available, are combined to provide a product or products that provide results that are most desirable to the individual purchasing or consuming the product.

It should be appreciated that the compositions of the present disclosure can be used as nutritional ingredients in a wide variety of dietary supplements and nutraceutical food and beverage products, including but not limited to bars, shakes, powders, pre-packaged foods and other health-related products.

It should also be appreciated from the data and bar graphs in FIGS. 1-16, that it is within the scope of the present invention to provide different types and amounts of soy albumins to provide a desired effect. For example, and not by the way of limitation, it is within the scope of the present invention to provide an effective amount of SLPF1N alone or effective amounts of the ingredients listed in groups 2 or 6 of table 2 (or any other combination that demonstrated favorable results) in any form that is known in the art (e.g., bar, capsule, power, food, liquid, shake) to achieve weight loss in a mammal. Similarly, it should also be appreciated that the present invention includes products or formulations containing soy albumin (alone and in combination with other ingredients) according to results disclosed herein that showed a beneficial effect for a particular purpose (e.g., lower LDL cholesterol). In should also be appreciated that it is also within the scope of this invention to provide effective amounts soy albumin with other products or compositions known to achieve a particular results.

The foregoing detailed description of the present disclosure is provided for the purposes of illustration, and is not intended to be exhaustive or to limit the disclosure to the particular embodiments disclosed. The embodiments may provide different capabilities and benefits, depending on the configuration used to implement the key features of the disclosure. Accordingly, the scope of the present disclosure is defined only by the following claims.

I claim:

1. A product for reducing weight in a mammal, the product comprising:
an effective amount of soy albumin;
wherein consumption of the effective amount of soy albumin by a mammal reduces the weight of the mammal.

2. A product of claim 1, wherein the effective amount of the soy albumin is 50 mg to 3000 mg.

3. A product of claim 1, wherein the effective amount of the soy albumin is 300 mg to 3000 mg of soy albumin daily.

4. A product of claim 1, wherein the effective amount of soy albumin provides the mammal with 100 mg to 500 mg of soy albumin daily and the soy albumin is not roasted.

5. A product of claim 1, wherein the effective amount of soy albumin is 100 mg to 6000 mg of soy albumin and the product further includes an effective amount of at least two items from the following group of items: fenugreek, phaseolamine, and bicarbonate.

6. A product of claim 5, wherein the effective amount of fenugreek provides 2 g to 8 g of fenugreek to the mammal daily, the effective amount of phaseolamine provides 0.1 g to 1.0 g phaseolamine to the mammal daily and the effective amount of bicarbonate provides 0.1 g to 1.0 g of bicarbonate to the mammal daily and the product is provided as part of a bar, powder or capsule.

7. A product for providing at least one health-related benefit to a mammal, the product comprising;
an effective amount of soy albumin;
wherein consumption of the effective amount of soy albumin by a mammal results in one or more of the following health-related benefits occurring to the mammal:
a. weight loss
b. lowered or improved BMI;
c. reduced total cholesterol levels;
d. reduced LDL cholesterol levels;
e. increased HDL or good cholesterol levels;
f. improved total cholesterol/HDL ratio;
g. improved LDL/HDL ratio;
h. reduced triglyceride levels;
i. increased serum serotonin levels; and
j. decreased fasting blood glucose levels.

8. A product of claim 7, wherein the consumption of the effective amount of soy albumin by a mammal results in two or more of the health-related benefits occurring to the mammal.

9. A product of claim 7, wherein consumption of the effective amount of soy albumin by a mammal results in all of the health-related benefits occurring to the mammal.

10. A product of claim 7, wherein the causing one or more of the health-related benefits to occur in the mammal treats, improves or prevents the onset of Syndrome X.

11. A product of claim 7, wherein the consumption of the effective amount of soy albumin treats, improves or prevents the onset of Syndrome X by improving or eliminating one or more cardiovascular or metabolic risk factors that cause Syndrome X.

12. A product of claim 7, wherein the effective amount of the soy albumin is 50 mg to 3000 mg.

13. A product of claim 7, wherein the effective amount of the soy albumin is 300 mg to 3000 mg.

14. A product of claim 7, wherein the effective amount of the soy albumin provides the mammal with 100 mg to 500 mg of soy albumin is not roasted.

15. A product of claim 7, wherein the effective amount of soy albumin is 100 mg to 6000 mg of soy albumin and the product further includes and effective amount of at least two items from the following group of items: fenugreek, phaseolamine, and bicarbonate.

16. A product of claim 15, wherein the effective amount of fenugreek provides 2 g to 8 g of fenugreek to the mammal daily, the effective amount phaseolamine provides 0.1 g to 1.0 g phaseolamine to the mammal daily and the effective amount of bicarbonate provides 0.1 to 1.0 g of bicarbonate to the mammal daily and the product is provided as a part of a bar, powder or capsule.

17. A method for providing health-related benefits to a mammal, the method comprising:
a. providing a product containing an effective amount of soy albumin to a mammal; and
b. claiming that the products provides any combination of one or more of the following benefits:
i. weight loss
ii. lowers or improves BMI;
iii. reduces or improves total cholesterol levels;
iv. reduces or improves LDL cholesterol levels;
v. increases or improves HDL or good cholesterol levels;
vi. improves total cholesterol/HDL ratio;
vii. improves LDL/HDL ratio;
viii. reduces or improves triglyceride levels;
ix. increases or improves serum serotonin levels;
x. decreases or improves fasting blood glucose levels; and
xi. prevents, improves or treats Syndrome X or the cardiovascular or metabolic factors that cause Syndrome X.

18. A method of claim 17, wherein the effective amount of the soy albumin is 50 mg to 3000 mg.

19. A method of claim 17, wherein the effective amount of the soy albumin is 300 mg to 3000 mg of soy albumin daily.

20. A method of claim 17, wherein the effective amount of the soy albumin provides the mammal with 100 mg to 500 mg of soy albumin daily and the soy albumin is not roasted.

21. A method of claim 17, the effective amount of soy albumin is 100 mg to 6000 mg of soy albumin and the product further includes and effective amount of at least two items from the following group of items: fenugreek, phaseolamine, and bicarbonate.

22. A method of claim 21, wherein the effective amount of fenugreek provides 2 g to 8 g of fenugreek to the mammal daily, the effective amount phaseolamine provides 0.1 g to 1.0 g phaseolamine to the mammal daily and the effective amount of bicarbonate provides 0.1 g to 1.0 g of bicarbonate to the mammal daily and the product is provided as a part of a bar, powder or capsule.

23. A method for providing health-related benefits to a mammal, the method comprising:
a. providing a product containing an effective amount of soy albumin to a mammal; and
b. claiming that the product provides any combination if three or more of the following benefits:
i. weight loss;
ii. lowers or improves BMI;
iii. reduces or improves total cholesterol levels;
iv. reduces or improves LDL cholesterol levels;
v. increases or improves HDL or good cholesterol levels;
vi. improves total cholesterol/HDL ratio;
vii. improves LDL/HDL ratio;
viii. reduces or improves triglyceride levels;
ix. increases or improves serum serotonin levels;
x. decreases or improves fasting blood glucose levels; and
xi. prevents, improves or treats Syndrome X or the cardiovascular or metabolic factors that cause Syndrome X.

24. A method of claim 23, wherein the effective amount of the soy albumin is 50 mg to 3000 mg.

25. A method of claim 23, wherein the effective amount of the soy albumin is 300 mg to 3000 mg of soy albumin daily.

26. A method of claim 23, wherein the effective amount of the soy albumin provides the mammal with 100 mg to 500 mg of soy albumin daily and the soy albumin is not roasted.

27. A method of claim 23, wherein the effective amount of soy albumin is 100 mg to 6000 mg of soy albumin and the product further includes an effective amount of at least one item from the following group of items: fenugreek, phaseolamine, bicarbonate.

28. A method of claim 27, wherein the effective amount of fenugreek provides 2 g to 8 g of fenugreek to the mammal daily, the effective amount of phaseolamine provides 0.1 g to 1.0 g phaseolamine to the mammal daily and the effective amount of bicarbonate provides 1.0 g to 1.0 g of bicarbonate to the mammal daily and the product is provided as part of a bar, powder or capsule.
